(19) United States
(12) Patent Application Publication
(10) Pub. No.: US 2022/0024073 A1
(43) Pub. Date: Jan. 27, 2022

(54) CRYSTAL INGOT CUTTING DEVICE AND CRYSTAL INGOT CUTTING METHOD

(71) Applicant: GlobalWafers Co., Ltd., Hsinchu (TW)

(72) Inventor: Ching-Shan Lin, Hsinchu (TW)

(73) Assignee: GlobalWafers Co., Ltd., Hsinchu (TW)

(21) Appl. No.: 17/385,909

(22) Filed: Jul. 27, 2021

Related U.S. Application Data
(60) Provisional application No. 63/056,726, filed on Jul. 27, 2020.

(51) Int. Cl. B28D 5/04; B28D 5/00

(52) U.S. Cl. CPC B28D 5/042; B28D 5/007; B28D 5/0082

(57) ABSTRACT

A crystal ingot cutting device and a crystal ingot cutting method are provided. The crystal ingot cutting device includes a driving unit, at least one cutting wire and a plurality of abrasive particles. The cutting wire is connected to the driving unit, wherein the driving unit drives a crystal ingot to move to the cutting wire and drives the cutting wire to reciprocate. A moving speed of the crystal ingot is 10˜700 μm/min, and a reciprocating speed of the cutting wire is 1800˜5000 m/min. The plurality of abrasive particles are arranged on the cutting wire, and a particle size of each abrasive particle is 5˜50 μm.

### CROSS REFERENCE TO RELATED APPLICATION

This application claims the priority benefit of U.S. provisional application Ser. No. 63/056,726, filed on Jul. 27, 2020. The entirety of the above-mentioned patent application is hereby incorporated by reference herein and made a part of specification.

### BACKGROUND

### Technical Field

The disclosure relates to a cutting device and a cutting method, and more particularly to a crystal ingot cutting device and a crystal ingot cutting method.

### Description of Related Art

In the semiconductor industry, wafer fabrication technology is very important. Generally speaking, the method of manufacturing wafers include forming a crystal ingot first, and then slicing the crystal ingot to obtain wafers. The cutting tool for slicing the crystal ingot is, for example, a cutting wire, and a plurality of abrasive particles are arranged on the cutting wire, and the cutting wire reciprocates to cut the crystal ingot. During the cutting process, the crystal ingot and the cut wafer can be easily damaged, which makes the cut wafer to have high surface roughness (Ra) and total thickness variation (TTV), which in turn causes the increase in the total removal amount in the subsequent wafer grinding and polishing process. As a result, not only that the cost is increased but also the quality of wafer is reduced.

### SUMMARY

The disclosure provides a crystal ingot cutting device, the surface of the cut wafer has high flatness.

The disclosure provides a crystal ingot cutting method, the surface of the cut wafer has high flatness.

A crystal ingot cutting device of the disclosure includes a driving unit, at least one cutting wire and a plurality of abrasive particles. The cutting wire is connected to the driving unit, the driving unit drives a crystal ingot to move to the cutting wire and drives the cutting wire to reciprocate. A moving speed of the crystal ingot is 10.5˜700 μm/min, and a reciprocating speed of the cutting wire is 1800˜5000 m/min. The plurality of abrasive particles are arranged on the cutting wire, and a particle size of each abrasive particle is 5˜50 μm.

The crystal ingot cutting method of the disclosure includes the following steps. The crystal ingot is driven to move to the cutting wire, the moving speed of the crystal ingot is 10˜700 μm/min. The cutting wire is driven to reciprocate to cut the crystal ingot by a plurality of abrasive particles on the cutting wire. The reciprocating speed of the cutting wire is 1800˜5000 m/min, and the particle size of each abrasive particle is 5˜50 μm.

In an embodiment of the disclosure, the wire diameter of the cutting wire is 50 to 200 μm.

In an embodiment of the disclosure, the tension of the cutting wire is 10 to 50N.

In an embodiment of the disclosure, the cutting wire includes a plurality of cutting wires parallel to each other.

In an embodiment of the disclosure, the cutting wire is a steel wire.

In an embodiment of the disclosure, each of the abrasive particles is a diamond particle.

In an embodiment of the disclosure, the moving speed of the crystal ingot is positively related to the reciprocating speed of the cutting wire.

In an embodiment of the disclosure, the particle size of each abrasive particle is negatively related to the reciprocating speed of the cutting wire.

In an embodiment of the disclosure, the driving unit drives the cutting wire to swing, and the swing angle of the cutting wire is 3 to 10 degrees.

In an embodiment of the disclosure, the driving unit drives the cutting wire to swing, and the swing angular velocity of the cutting wire is 100 to 300 degrees/min.

Based on the above, in the crystal ingot cutting device of the disclosure, the particle size of the abrasive particles on the cutting wire is 5 to 50 μm. In addition, the driving unit drives the crystal ingot to move to the cutting wire at a moving speed of 10 to 700 μm/min, and drives the cutting wire to reciprocate at a reciprocating speed of 1800 to 5000 m/min. Therefore, the damage to the crystal ingot and the cut wafer can be reduced with the smaller particle size of the abrasive particles, and the reciprocating speed of the cutting wire and the moving speed of the crystal ingot are fast enough to eliminate the influence caused to the cutting efficiency due to the reduced particle size of the abrasive particles. In this manner, under the premise of maintaining good cutting efficiency, the crystal ingot cutting device can effectively reduce the damage caused to the crystal ingot and the cut wafer. Therefore, the surface of the wafer cut by the crystal ingot cutting device has lower roughness and lower total thickness variation, and the total removal amount in the subsequent wafer grinding and polishing process can be effectively reduced.

In order to make the above-mentioned features and advantages of the disclosure more obvious and understandable, the following specific embodiments are described in detail in conjunction with the accompanying drawings.

### BRIEF DESCRIPTION OF THE DRAWINGS

FIG. 1 is a three-dimensional schematic view of a crystal ingot cutting device according to an embodiment of the disclosure.

FIG. 2 is a schematic view showing the operation of the crystal ingot cutting device of FIG. 1.

FIG. 3 is a partial enlarged schematic view of the cutting wire of FIG. 2 swinging relative to the crystal ingot.

FIG. 4 is a partial enlarged schematic view of the cutting wire of FIG. 1.

### DESCRIPTION OF THE EMBODIMENTS

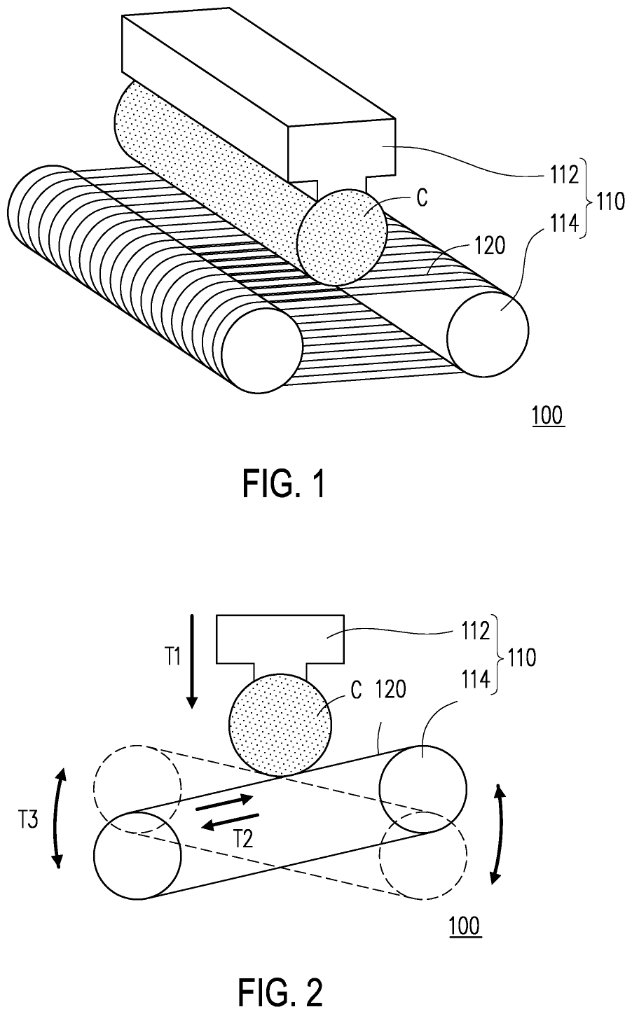

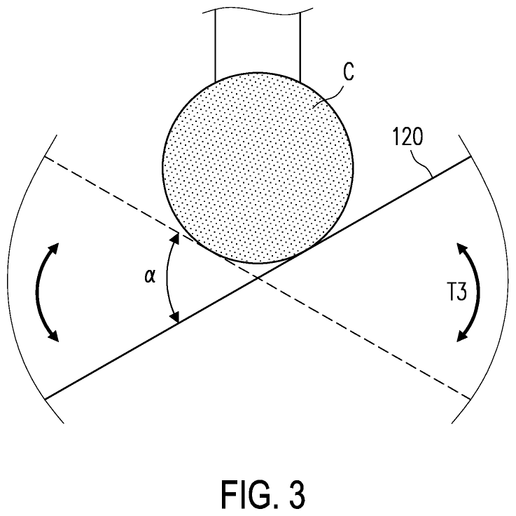

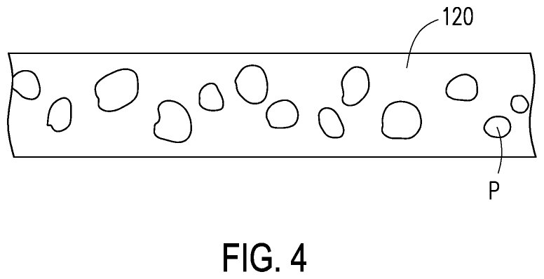

FIG. 1 is a three-dimensional schematic view of a crystal ingot cutting device according to an embodiment of the disclosure. FIG. 2 is a schematic view showing the operation of the crystal ingot cutting device of FIG. 1. FIG. 3 is a partial enlarged schematic view of the cutting wire of FIG. 2 swinging relative to the crystal ingot. FIG. 4 is a partial enlarged schematic view of the cutting wire of FIG. 1. Please refer to FIG. 1, FIG. 2, FIG. 3, and FIG. 4. The crystal ingot cutting device 100 of this embodiment is configured for slicing a crystal ingot C to obtain a wafer. The crystal ingot cutting device 100 includes a driving unit 110, at least one cutting wire 120, and a plurality of abrasive particles P.

The driving unit 110 drives the crystal ingot C to move to the cutting wire 120. In this embodiment, the driving unit 110 actually includes a pick-and-place tool 112. The pick-and-place tool 112 fixes the crystal ingot C from the top of the crystal ingot cutting device 100, and drives the crystal ingot C to move downward toward the cutting wire 120 (as shown by path T1 in FIG. 2).

In addition, in some embodiments, the pick-and-place tool 112 fixes the crystal ingot C (not shown) under the crystal ingot cutting device 100, and drives the crystal ingot C to move upward toward the cutting wire 120. In this embodiment, the positions of the pick-and-place tool 112 and the crystal ingot C fixed above the pick-and-place tool 112 relative to two main wheels 114 and the cutting wire 120 are opposite to those shown in FIG. 1. That is to say, the pick-and-place tool 112 and the crystal ingot C fixed above the pick-and-place tool 112 are both arranged under the two main wheels 114 and the cutting wire 120. With the arrangement of such relative position, the driving unit 110 can also drive the crystal ingot C to move upward toward the cutting wire 120, and the disclosure provides no limitation thereto.

The driving unit 110 drives the cutting wire 120 to reciprocate. In this embodiment, the driving unit 110 actually includes two main wheels 114, and the cutting wire 120 is connected to the two main wheels 114. The two main wheels 114 are controlled to reciprocate and deflect at the same speed, so that the cutting wire 120 swings from side to side and reciprocate (as indicated by the path T2 and the path T3 in FIG. 2 respectively), so as to cut the crystal ingot C, but the disclosure provides no limitation thereto.

The crystal ingot cutting method of this embodiment includes the following steps. The crystal ingot C is driven to move to the cutting wire 120, the moving speed of the crystal ingot C is 10˜700 μm/min. The cutting wire 120 is driven to reciprocate to cut the crystal ingot C with the plurality of abrasive particles P on the cutting wire 120, and the reciprocating speed of the cutting wire 120 is 1800˜5000 m/min, and the particle size of each abrasive particle P is 5˜50 μm.

In this manner, it is possible to reduce the damage to the crystal ingot C and the cut wafer with the smaller particle size of the abrasive particles P, and the reciprocating speed of the cutting wire 120 and the moving speed of the crystal ingot C are fast enough to eliminate the influence caused to the cutting efficiency due to the reduced particle size of the abrasive particles P. Accordingly, under the premise of maintaining good cutting efficiency, the crystal ingot cutting device 100 can effectively reduce the damage caused to the crystal ingot C and the cut wafer. Therefore, the surface of the wafer cut by the crystal ingot cutting device 100 has lower roughness (Ra) and lower total thickness variation (TTV), and the total removal amount in the subsequent wafer grinding and polishing process can be effectively reduced, thereby saving costs and enhancing the quality of wafer.

In this embodiment, the moving speed of the crystal ingot C is preferably 10 to 50 μm/min, 10 to 80 μm/min, 50 to 150 μm/min, more preferably 250 to 350 μm/min, 250 to 500 μm/min, and 350 to 700 μm/min. The reciprocating speed of the cutting wire 120 is preferably 1900 to 3000 m/min, and more preferably 3000 to 4000 m/min, 4000˜5000 m/min.

Further, in this embodiment, the moving speed of the crystal ingot C is positively related to the reciprocating speed of the cutting wire 120. For example, when the reciprocating speed of the cutting wire 120 is too fast but the moving speed of the crystal ingot C is too slow, the cutting wire 120 might have cut the crystal ingot C, but the crystal ingot C has not moved forward yet. In that case, the cutting wire 120 continues to cut the crystal ingot C repeatedly in the same area, which will cause damage to the crystal ingot C and the cut wafer. Therefore, when the reciprocating speed of the cutting wire 120 increases, the moving speed of the crystal ingot C must also increase. In this manner, it is possible to effectively reduce the damage to the crystal ingot C and the cut wafer.

On the contrary, when the moving speed of the crystal ingot C is too fast but the reciprocating speed of the cutting wire 120 is too slow, the cutting wire 120 might not be able to cut the crystal ingot C yet, and the driving unit 110 continues to drive the crystal ingot C to move forward. Under the circumstances, the cutting wire 120 is prone to breakage, which will cause damage to the crystal ingot C and the cut wafer, and even cause deviations in the geometric shape of the wafer. Therefore, when the moving speed of the crystal ingot C increases, the reciprocating speed of the cutting wire 120 must also increase. In this manner, it is possible to effectively reduce the damage to the crystal ingot C and the cut wafer.

In this embodiment, each abrasive particle P is, for example, a diamond particle. The particle size of each abrasive particle P is preferably 10 to 50 μm, more preferably 30 to 40 μm, and may also be 5 to 10 μm, 10 to 20 μm or 40 to 50 μm. Furthermore, in this embodiment, the particle size of each abrasive particle P is negatively related to the reciprocating speed of the cutting wire 120. In other words, the smaller the particle size of the abrasive particles P, the faster the cutting speed of the cutting wire 120. Accordingly, good cutting efficiency can be maintained while smaller particle size of the abrasive particles P can decrease the damage caused to the crystal ingot and the cut wafer.

In this embodiment, the cutting wire 120 is, for example, a steel wire. The wire diameter of the cutting wire 120 is, for example, 50 to 200 preferably 60 to 180 and more preferably 80 to 140 In this embodiment, the tension of the cutting wire 120 is, for example, 10 to 50 N, preferably 15 to 35 N, and more preferably 20 to 30 N. In this way, the cutting wire 120 can provide sufficient supporting force during the cutting process, and a good cutting effect can be achieved.

In this embodiment, the cutting wire 120 includes a plurality of cutting wires 120 parallel to each other, and the spacing between the plurality of cutting wires 120 is substantially the thickness of the wafer. In this way, the crystal ingot cutting device 100 can cut a plurality of wafers at a time.

As shown in FIG. 3, in this embodiment, the main wheel 114 of the driving unit 110 drives the cutting wire 120 to swing along the path T3, and the swing angle α of the cutting wire 120 is, for example, 3 to 10 degrees, preferably 3 to 8 degrees, and more preferably 3 to 5 degrees. In addition, as the cutting wire 120 swings, the inclination angle of the cutting wire 120 relative to the horizontal plane on the path T3 changes accordingly, and the rate of change of this angle can be regarded as the swing angular velocity of the cutting wire 120. The swing angular velocity of the cutting wire 120 is, for example, 100 to 300 degrees/min, preferably 150 to 250 degrees/min, or 180 to 280 degrees/min.

A number of examples are listed below to further illustrate the crystal ingot cutting device 100 of the disclosure. Although the following experiments are described, the materials used, the amounts and ratios of the materials, processing details, processing procedures, etc. can be appropriately changed without going beyond the scope of the disclosure. Therefore, the experiments described below should not be construed as a limitation to the disclosure.

TABLE 1

| | Wafer | Wafer | Wafer | Wafer | Wafer | Wafer | Wafer | Wafer | Wafer |
|---|---|---|---|---|---|---|---|---|---|
| | 1 | 2 | 3 | 4 | 5 | 6 | 7 | 8 | 9 |
| Particle size | 30/40 | 30/40 | 30/40 | 30/40 | 60/70 | 5/10 | 10/20 | 20/30 | 20/30 |
| of abrasive | | | | | | | | | |
| particles | | | | | | | | | |
| (μm) | | | | | | | | | |
| diameter of | 120 | 120 | 120 | 120 | 120 | 120 | 120 | 120 | 120 |
| cutting wire | | | | | | | | | |
| (μm) | | | | | | | | | |
| moving speed | 3.5 | 5.5 | 8.5 | 25.0 | 30.0 | 350.0 | 300.0 | 80.0 | 350.0 |
| of crystal | | | | | | | | | |
| ingot | | | | | | | | | |
| (μm/min) | | | | | | | | | |
| Reciprocating | 1300 | 1500 | 1800 | 1000 | 2000 | 4500 | 4000 | 2500 | 2500 |
| speed of | | | | | | | | | |
| cutting wire | | | | | | | | | |
| (m/min) | | | | | | | | | |
| tension of | 20 | 20 | 20 | 20 | 20 | 20 | 20 | 20 | 20 |
| cutting wire | | | | | | | | | |
| (N) | | | | | | | | | |
| Total | 35 | 31 | 24 | 36 | 35 | 4 | 4 | 10 | 8 |
| thickness | | | | | | | | | |
| variation | | | | | | | | | |
| (μm) | | | | | | | | | |
| Roughness | 1.5 | 1.2 | 1.1 | 2 | 2.2 | 0.2 | 0.3 | 0.7 | 0.4 |
| (μm) | | | | | | | | | |
| Total removal | 200 | 150 | 100 | 200 | 230 | 15 | 20 | 60 | 40 |
| amount | | | | | | | | | |
| (μm) | | | | | | | | | |

| | Wafer | Wafer | Wafer | Wafer | Wafer | Wafer | Wafer | Wafer | Wafer | Wafer |
|---|---|---|---|---|---|---|---|---|---|---|
| | 10 | 11 | 12 | 13 | 14 | 15 | 16 | 17 | 18 | 19 |
| Particle | 20/30 | 20/30 | 30/40 | 30/40 | 30/40 | 30/40 | 40/50 | 40/50 | 40/50 | 40/50 |
| size of | | | | | | | | | | |
| abrasive | | | | | | | | | | |
| particles | | | | | | | | | | |
| (μm) | | | | | | | | | | |
| diameter | 120 | 120 | 120 | 120 | 120 | 120 | 120 | 120 | 120 | 120 |
| of cutting | | | | | | | | | | |
| wire | | | | | | | | | | |
| (μm) | | | | | | | | | | |
| moving | 500.0 | 700.0 | 10.0 | 50.0 | 150.0 | 550.0 | 75.0 | 125.0 | 250.0 | 500.0 |
| speed of | | | | | | | | | | |
| crystal | | | | | | | | | | |
| ingot | | | | | | | | | | |
| (μm/min) | | | | | | | | | | |
| Reciprocating | 4000 | 5000 | 1800 | 2500 | 3000 | 2500 | 2500 | 2000 | 1900 | 1800 |
| speed of | | | | | | | | | | |
| cutting | | | | | | | | | | |
| wire | | | | | | | | | | |
| (m/min) | | | | | | | | | | |
| tension | 20 | 20 | 20 | 20 | 20 | 20 | 20 | 20 | 20 | 20 |
| of cutting | | | | | | | | | | |
| wire (N) | | | | | | | | | | |
| Total | 6 | 4 | 16 | 11 | 8 | 8 | 18 | 18 | 18 | 18 |
| thickness | | | | | | | | | | |
| variation | | | | | | | | | | |
| (μm) | | | | | | | | | | |
| Rough- | 0.3 | 0.1 | 0.7 | 0.4 | 0.3 | 0.1 | 0.8 | 0.7 | 0.6 | 0.5 |
| ness | | | | | | | | | | |
| (μm) | | | | | | | | | | |
| Total | 35 | 25 | 80 | 50 | 45 | 30 | 90 | 80 | 60 | 50 |
| removal | | | | | | | | | | |
| amount | | | | | | | | | | |
| (μm) | | | | | | | | | | |

It can be seen from Table 1 that the moving speed of the crystal ingots of wafers 1 and 2 and the reciprocating speed of the cutting wire do not satisfy the range specified above, and the moving speed of the crystal ingot of wafer 3 does not satisfy the range specified above. The reciprocating speed of the cutting wire of the wafer 4 does not satisfy the range specified above, and the particle size of the abrasive particles of the wafer 5 does not satisfy the range specified above. On the other hand, the moving speeds of the crystal ingots, the reciprocating speed of the cutting wires, and the particle size of the abrasive particles of the wafers 6 to 19 satisfy the range specified above.

As shown in Table 1, when the moving speed of the crystal ingot C and/or the reciprocating speed of the cutting wire 120 does not satisfy the range specified above, the roughness and total thickness variation of the wafers 1 to 4 are high. In other words, during the cutting process, the crystal ingot C and the cut wafer suffer severe damage. Therefore, the total removal amount of wafers 1 to 4 during subsequent grinding and polishing processing is also large, which will increase the workload on subsequent processing, and will also cause waste of materials and costs.

In contrast, for wafers 6 to 19, when the moving speed of the crystal ingot C and the reciprocating speed of the cutting wire 120 satisfy the range specified above, the roughness and total thickness variation of the wafers 6 to 19 are significantly low, and the surfaces of the wafers 6˜19 have better flatness. Therefore, the total removal amounts of wafers 6 to 19 during subsequent grinding and polishing processing are relatively small. In this embodiment, the total removal amounts of the wafers 6 to 19 are all less than 100 μm.

In addition, as shown in Table 1, when the abrasive particles P do not satisfy the range specified above, for example, the wafer 5 has a high level of roughness and total thickness variation. In other words, during the cutting process, although the wafer 5 is cut with the same wire diameter of the cutting wire 120, the tension of the cutting wire 120, and the moving speed of the crystal ingot C and the reciprocating speed of the cutting wire 120 that satisfy the range specified above, since the abrasive particle P does not satisfy the range specified above, the crystal ingot C and the cut wafer suffer great damage. Therefore, the total removal amount of the wafer 5 during subsequent grinding and polishing processing is also large, which will increase the workload on subsequent processing and will also cause waste of materials.

In contrast, for wafers 6 to 19, when the abrasive particles P satisfy the range specified above, the roughness and total thickness variation of the wafers 6 to 19 are significantly low, and the surfaces of the wafers 6˜19 have better flatness. Therefore, the total removal amounts of wafers 6 to 19 during subsequent grinding and polishing processing are relatively small. In this embodiment, the total removal amounts of the wafers 6 to 19 are all less than 100 μm.

In summary, in the crystal ingot cutting device of the disclosure, the particle size of the abrasive particles on the cutting wire is 5 to 50 In addition, the driving unit drives the crystal ingot to move to the cutting wire at a moving speed of 10 to 700 μm/min, and drives the cutting wire to reciprocate at a reciprocating speed of 1800 to 5000 m/min. Therefore, the damage to the crystal ingot and the cut wafer can be reduced with the smaller particle size of the abrasive particles, and the reciprocating speed of the cutting wire and the moving speed of the crystal ingot are fast enough to eliminate the influence caused to the cutting efficiency due to the reduced particle size of the abrasive particles. In this manner, under the premise of maintaining good cutting efficiency, the crystal ingot cutting device can effectively reduce the damage caused to the crystal ingot and the cut wafer. Therefore, the surface of the wafer cut by the crystal ingot cutting device has lower roughness and lower total thickness variation, and the total removal amount in the subsequent wafer grinding and polishing process can be effectively reduced.

Although the disclosure has been disclosed in the above embodiments, it is not intended to limit the disclosure. Anyone with ordinary knowledge in the technical field can make some changes and modification to the embodiments without departing from the spirit and scope of the disclosure. Therefore, the scope to be protected by the disclosure shall be subject to the scope of the appended claims.

What is claimed is:

1. A crystal ingot cutting device, comprising:
a driving unit;
at least one cutting wire connected to the driving unit, wherein the driving unit drives a crystal ingot to move to the at least one cutting wire and drives the at least one cutting wire to reciprocate, a moving speed of the crystal ingot is 10˜700 μm/min, a reciprocating speed of the at least one cutting wire is 1800˜5000 m/min; and
a plurality of abrasive particles arranged on the at least one cutting wire, wherein a particle size of each of the plurality of abrasive particles is 5˜50 μm.

2. The crystal ingot cutting device according to claim 1, wherein a wire diameter of the at least one cutting wire is 50˜200 μm.

3. The crystal ingot cutting device according to claim 1, wherein a tension of the at least one cutting wire is 10˜50N.

4. The crystal ingot cutting device according to claim 1, wherein the moving speed of the crystal ingot is positively related to the reciprocating speed of the at least one cutting wire.

5. The crystal ingot cutting device according to claim 1, wherein the particle size of each of the plurality of abrasive particles is negatively related to the reciprocating speed of the at least one cutting wire.

6. The crystal ingot cutting device according to claim 1, wherein the driving unit drives the at least one cutting wire to swing, and a swing angle of the at least one cutting wire is 3 to 10 degrees.

7. The crystal ingot cutting device according to claim 1, wherein the driving unit drives the at least one cutting wire to swing, and a swing angular velocity of the at least one cutting wire is 100 to 300 degrees/min.

8. A crystal ingot cutting method, comprising:
driving a crystal ingot to move to at least one cutting wire, wherein a moving speed of the crystal ingot is 10˜700 μm/min; and
driving the at least one cutting wire to reciprocate to cut the crystal ingot by a plurality of abrasive particles on the at least one cutting wire, wherein a reciprocating speed of the at least one cutting wire is 1800˜5000 m/min,
wherein a particle size of each of the plurality of abrasive particles is 5˜50 μm.

9. The crystal ingot cutting method according to claim 8, wherein a wire diameter of the at least one cutting wire is 50 to 200 μm.

10. The crystal ingot cutting method according to claim 8, wherein a tension of the at least one cutting wire is 10˜50N.
